(19) United States
(12) Patent Application Publication
(10) Pub. No.: US 2005/0177638 A1
(43) Pub. Date: Aug. 11, 2005

(54) Apparatus and method for broadcasting data within wireless communication service area

(76) Inventor: Jong-Teak OH, Seoul (KR)

Correspondence Address: DILWORTH & BARRESE, LLP, 333 EARLE OVINGTON BLVD., UNIONDALE, NY, 11553, US

(21) Appl. No.: 10/515,795

(22) PCT Filed: May 27, 2003
(86) PCT No.: PCT/KR03/01039

(30) Foreign Application Priority Data
May 28, 2002 (KR) 10-2002-0029707
Sep. 17, 2002 (KR) 10-2002-0056456
Apr. 4, 2003 (KR) 10-2003-0021524

(51) Int. Cl. G06F 15/16

(52) U.S. Cl. 709/227; 709/228

(57) ABSTRACT

An apparatus and method for broadcasting datagram in a wireless communication service area is disclosed. The apparatus includes: broadcasting control unit for controlling to provide broadcasting service within the wireless communication service area: Internet access unit for receiving a datagram of broadcasting through the Internet under control of the broadcasting control unit; address convert unit for converting a destination IP address of the datagram to a predetermined type of IP address suitable for broadcasting under control of the broadcasting control unit: and wireless communication unit for transmitting the datagram having the predetermined type of address based on a predetermined communication method to corresponding terminal located within the wireless communication service area under control of the broadcasting controlling unit. The present invention can effectively provide valuable local information to users of specific area.

### TECHNICAL FIELD

The present invention relates to a technique field of wireless broadcasting service; and, more particularly, to an apparatus and method for reputedly transmitting broadcasting data received through the Internet to a plurality of mobile IP terminals, which are located inside of wireless communication service area, without information of IP address of a broadcasting server by using wireless base stations in case that the IP address of the terminal is frequently changed caused by mobility of the terminal.

### BACKGROUND ARTS

Recently, availability of information has been incredibly increased and ownership of information has been widely opened to the public by rapid development of the Internet. Also, the technology of communication has been developed for providing convenience and various Internet services. Such a development of communication technology makes it possible to provide a wireless Internet broadcasting service by using conventional wireless LAN access point (AP) as shown in FIG. 1. FIG. 1 is a diagram showing a system for conventional data broadcasting service system. Referring to FIG. 1, a wireless communication terminal 13 receives Internet broadcasting data from an Internet broadcasting server 11 through the wireless LAN access point AP 12, which provides a connection to the Internet. However, in the system of FIG. 1 requires a unique Internet protocol IP address for the wireless communication terminal 13 and requires pre-setting a web address of desired broadcasting site such as the Internet broadcasting server 11. Furthermore, when an Internet broadcasting company reputedly broadcasts identical broadcasting data within a wireless communication service area, the Internet broadcasting company needs to reputedly transmit identical broadcasting data to the wireless LAN access point 12. Therefore, the system of FIG. 1 is not efficient system and a work load or the internet broadcasting server 11 is increased when a plurality of terminals 13 accesses simultaneously to the Internet broadcasting server 11.

In other word, a datagram is transmitted to a receiver based on a unicasting IP address and multicasting IP address according to a communication protocol such as a User Datagram protocol/Internet Protocol (UDP/IP) in case of conventional Internet broadcasting. For receiving the multicasting datagram, the receiver needs to go through complex steps such as allocation of IP address and registration of receiving at multicasting router by using Internet Group Management Protocol IGMP. Moreover, the datagram needs to be transmitted to the wireless LAN access point 12 and the IP addresses need to be allocated to every terminal 13 within a communication area of the wireless LAN AP 12 for receiving the wireless Internet broadcasting data. Also, the IP address of the Internet broadcasting server 11 needs to be set at the terminal 13 for receiving the datagram.

Generally, there are three methods for transmitting datagram in the Internet such as unicasting, multicasting and anycasting.

The unicasting method transmits the datagram to only IP address of assigned receiver (terminal 13) ,from a transmitter (server 11) since the transmitter (server 11) is correspondence to the receiver (terminal 13) by one-to-one manner.

In case of the multicasting, the datagram is transmitted to a plural of receivers (terminals 13) included in a specific group. Therefore, a router contains registered IP addresses of receivers (terminals 13) and the datagram is transmitted to the terminals having the registered IP addresses.

In case of the broadcasting method, the datagram is transmitted to unspecified receivers (terminal 13).

In the meantime, the anycasting method transmits the datagram to a terminal, which has identical subnet address and located nearest to transmitter. It is used for IP version 6 (IPv6).

However, in case of broadcasting method, traffic of data may be congested since data traffic is spread to whole network among the transmitter and the receivers. It causes malfunctioning of communication. Therefore, the broadcasting method is not used for transmitting the datagram and it is used only for specific purpose such as confirmation of media access control (MAC) address or IP address in a subnet.

Also, the multicasting method requires complex steps including registering of receiving to multicasting router by using IGMP and multicasting routers need to be equipped at every networks. Therefore, it is difficult that the multicasting method is practically used.

Since the above mentioned disadvantaged of methods, the unicasting method is generally used for the Internet broadcasting service. In the unicasting method, the Internet broadcasting server 11 and a receiver 13 are correspondence by the one-to-one manner. However, the unicasting method also has disadvantages such as requirement of allocating unique IP address for each of receivers 13 and presetting of web address of Internet broadcasting server site 11 at the receiver 13 for receiving the data of the Internet broadcasting service.

Furthermore, in the Internet broadcasting service provided by the unicasting method, a workload of Internet server 11 and network is increased since a plurality of terminals 13 is simultaneously accessed to the Internet broadcasting server 11.

Moreover, in case that the Internet broadcasting server 11 reputedly transmits identical data to receivers 13 located in a wireless communication service area, the workload of server 11 is increased and data communication traffic is also increased.

Recently, wireless LAN, which is one of wireless base station, has been rapidly popularized in an area of dense population and therefore, valuable local information can be provided to users in a wireless communication service area by using the wireless LAN. Such a population of wireless LAN can be used for providing the Internet broadcasting service to users by using wireless base stations such as a mobile communication base station or a buletooth station.

Therefore, it has been demanded that an Internet broadcasting service system can reduce a workload of server, increase convenience of users by automatically receiving broadcasting data in a service area of wireless communication without complex steps of allocating unique IP address of terminals, also reduce a workload of server by preventing to reputedly transmitting identical broadcasting data and reduce communication traffic.

### DISCLOSURE OF THE INVENTION

It is, therefore, an object of the present invention to provide an apparatus and method for providing wireless Internet broadcasting service in order to reduce a workload of server and increasing convenience of a user by automatically receiving broadcasting data within a wireless communication service area without complex steps of allocation unique IP address of terminal.

It is also another object of the present invention to provide an apparatus and method for reducing a workload or server and communication traffic by reputedly broadcasting identical broadcasting data in every predetermined interval.

In accordance with an aspect of the present invention, there is also provided an apparatus for broadcasting data within a wireless communication service area including: broadcasting control unit for controlling to provide broadcasting service within the wireless communication service area; Internet access unit for receiving a datagram of broadcasting through the Internet under control of the broadcasting control unit; address convert unit for converting a destination IP address of the datagram to a predetermined type of IP address suitable for broadcasting under control of the broadcasting control unit; and wireless communication unit for transmitting the datagram having the predetermined type of IP address based on a predetermined communication method to corresponding terminal located within the wireless communication service area under control of the broadcasting controlling unit.

In accordance with another aspect of the present invention, there is also provided a method for broadcasting data in a service area of wireless communication including the steps of: a) receiving a datagram for broadcasting through the Internet; b) converting a destination IP address of the datagram to a predetermined type of IP address suitable for broadcasting; and c) transmitting the converted datagram having the predetermined type of IP address according to the predetermined communication method to corresponding terminal within the service area of the wireless communication.

In accordance with another aspect of the present invention, there is also provided a computer readable recording medium for recording a program for implementing a method of broadcasting data in a service area of wireless communication including the functions of: a) receiving a datagram for broadcasting through the Internet; b) converting a destination IP address of the datagram to a predetermined type of IP address suitable for broadcasting; and c) transmitting the converted datagram having the predetermined type of IP address according to the predetermined communication method to corresponding terminal within the service area of the wireless communication.

### BRIEF DESCRIPTION OF THE DRAWING(S)

The above and other objects and features of the present invention will become apparent from the following description of the preferred embodiments given in conjunction with the accompanying drawings, in which:

FIG. 1 is a diagram showing a system for conventional data broadcasting service system;

FIG. 2 is a diagram illustrating a data broadcasting apparatus equipped in a data broadcasting service system in accordance with a preferred embodiment of the present invention;

FIG. 3 shows a structure or internet protocol datagram;

FIG. 4 shows a detailed view of a payload in an IP datagram for broadcasting in accordance with a preferred embodiment of the present invention;

FIG. 5 is a flowchart for explaining a method for transmitting broadcasting data within a wireless communication service area in accordance with a preferred embodiment of the present invention; and

FIG. 6 shows steps for providing local Internet broadcasting service by implementing the broadcasting data apparatus 20 of the present invention in real driveways.

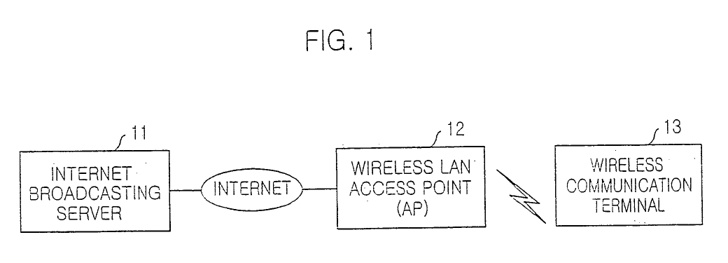

### MODES FOR CARRYING OUT THE INVENTION

Other objects and aspects of the invention will become apparent from the following description of the embodiments with reference to the accompanying drawings, which is set forth hereinafter.

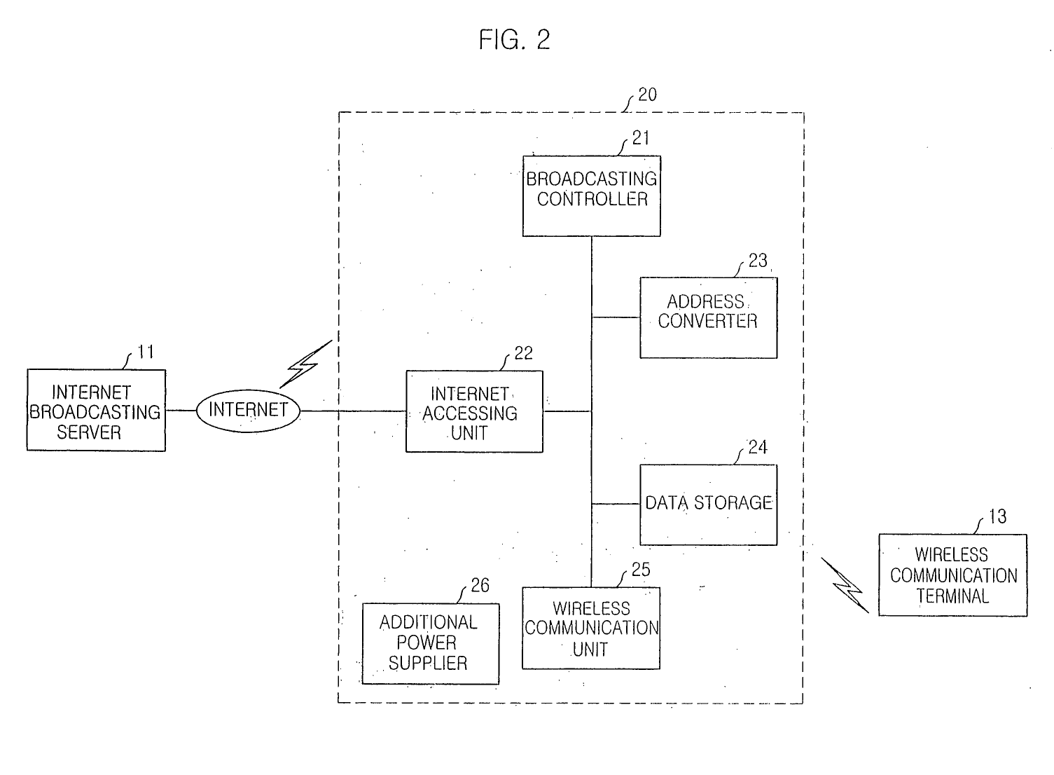

FIG. 2 is a diagram illustrating a data broadcasting apparatus equipped in a data broadcasting service system in accordance with a preferred embodiment of the present invention.

Referring to FIG. 2, the data broadcasting service system includes an Internet broadcasting server 11, a wireless communication terminal 13 and a data broadcasting apparatus 20 equipped in a wireless base station.

The wireless communication terminal 13 is a communication device, which can be carried by a user, wherein the communication device is a wireless communication terminal 13 including a personal digital assistant (DA), a notebook computer, a smart phone, a cellular phone or a PCS phones and a next generation wireless communication terminal includes an international mobile telecommunication (IMT)-2000 terminal and universal mobile telecommunication service (UMTS) terminal.

The data broadcasting apparatus 20 is equipped in the wireless base station and the Internet broadcasting server 11 receives the broadcasting data through the Internet. The broadcasting data is transmitted to a plurality of terminal 13 through the wireless communications.

Referring to FIG. 2, the data broadcasting apparatus 20 includes a broadcasting controller 21 for controlling broadcasting service within a wireless communication service area, an internet accessing unit 22 for receiving a datagram for broadcasting through the Internet, an address converter 23 for converting a destination IP address of the datagram to a predetermined communication type of IP address which is suitable for broadcasting under control of the broadcasting controller 21 and a wireless communication unit 25 for transmitting the datagram, which is converted to the predetermined communication type of IP address, to correspondent terminal 13 located within the wireless service area according to a predetermined communication type under control of the broadcasting controller 21. Also, the broadcasting data apparatus 20 further includes a data storage 26 for storing the converted datagram of the predetermined communication type such as broadcasting, multicasting and anycasting and reputedly transmitting the stored datagram in every predetermined interval according to the predetermined communication type through the wireless communication unit 25 and an additional power supplier 26 for supplying additional power to the data broadcasting apparatus 20 in case of emergency situation.

Hereinafter, detailed operations or the data broadcasting apparatus 20 are explained.

The Internet accessing unit 22 receives a datagram from the internet broadcasting server 11 by providing a connection to the internet.

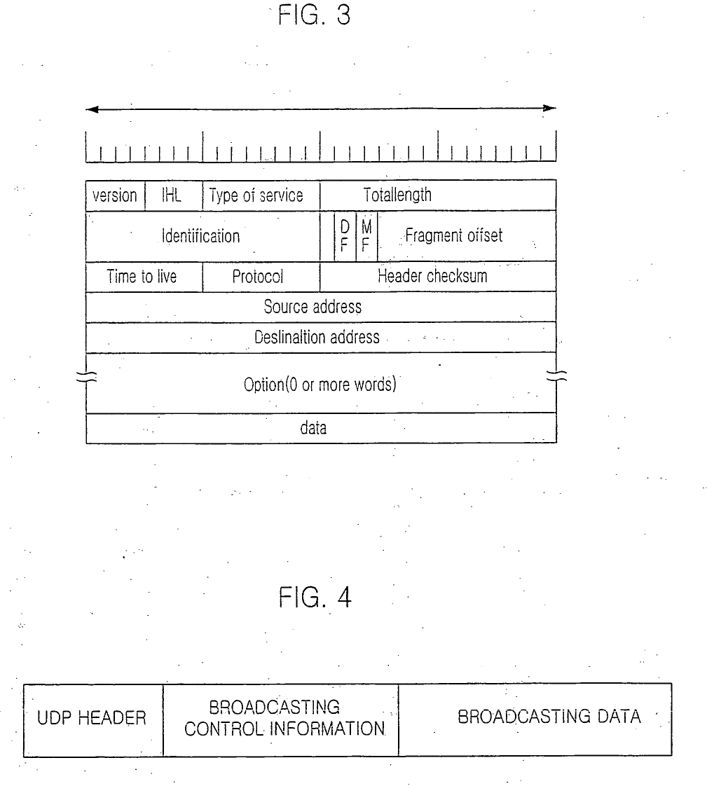

FIG. 3 shows a structure of Internet protocol datagram. As shown in FIG. 3, the datagram includes a source address and a destination address as Internet protocol IP address.

For example, a unique Internet protocol IP address is allocated to a wireless LAN accessing point AP for identifying the datagram for broadcasting. The Internet broadcasting server 11 transmits the datagram having an IP address of wireless LAN access point (AP) controlling corresponding area as a destination IP address for broadcasting local information of each area. The Internet accessing unit 22 recognizes a datagram having a destination IP address matched to the IP address of the wireless LAN accessing point (AP) as a datagram for broadcasting. At this time, if a destination address of a received datagram is not an IP address for broadcasting, the wireless LAN accessing point (AP) performs normal operations.

For another example, by previously setting a port number of user datagram protocol UDP as predetermined number, the datagram for broadcasting can be classified by checking the port number and an IP address of received datagram.

For another example, the data broadcasting apparatus 20 can also classify the datagram for broadcasting by analyzing a data filed in the payload of the UDP datagram.

In a meantime the address converter 23 converts a destination IP address included in the received datagram to an address of a predetermined type, which is suitable for a wireless broadcasting method.

For example, the destination IP address is converted to an Internet protocol (IP) address or broadcasting such as 255. 255. 255. 255 or the destination Is address is converted to predetermined type address, which is suitable for multicasting or anycasting.

For another example, a media access control (MAC) address of the destination or datalink address in the frame header can be set to the address of broadcasting or multicasting for all terminals 13 within wireless communication service area in order to received broadcasting data.

For further another example, each datalink address of the terminals can be stored at the broadcasting data apparatus 20 for transmitting broadcasting data to each of terminals by the datalink addresses.

The wireless communication terminal 13 receives data of Internet broadcasting service within the wireless communication service area without setting the Internet address of a broadcasting server of corresponding web sites and displays a desired datagram among received datagram. Additional information of received datagram can be supplied by using the link information, for example, by clicking on the linked text, one can move to corresponding web site. Also, for receiving broadcasting data, a function of automatically recognizing the wireless communication network is equipped in the wireless communication terminal 13. Furthermore, the datagram for broadcasting can be transmitted to other terminals within the wireless communication service area. Therefore, the users can share and pass received useful information each others.

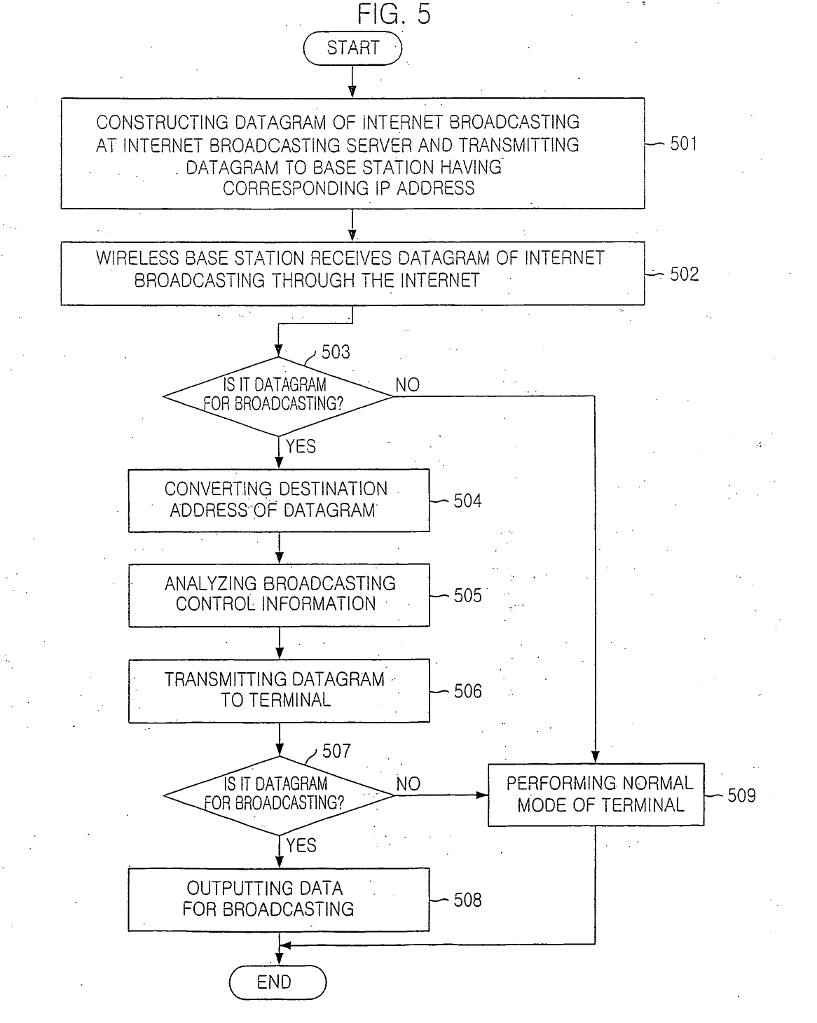

FIG. 4 shows a detailed view of a data field in a UDP datagram for broadcasting in accordance with a preferred embodiment of the present invention.

Referring to FIG. 4, a data id includes broadcasting control information consecutively coupled to UDP header. Therefore, the broadcasting controlling unit 21 reads the broadcasting control information and controls to broadcast the datagram for broadcasting and/or storing the datagram according to the broadcasting control information.

The broadcasting control information contains information including a store order field for determining whether the datagram is stored or not, a broadcasting time field for indicating a time for broadcasting and a broadcasting repetition field for indicating the number of broadcasting repetition or interval, priority and size.

Also, a header can include additional information filed for user verification and security. The operation of verification and security can be performed by using two-way communication function.

In a meantime, the wireless communication unit 25 transmits the datagram including new destination IP address to plural of receiving terminals 13 within a communication network through a wireless base station. In here, the new destination IP address is an address suitable for broadcasting and the plural of terminals 13 can receive the datagram by using the new destination address. Furthermore, a terminal can receive the datagram during moving.

The data storage 24 can be additionally included to the data broadcasting apparatus 20. The data storage 24 stores received datagram through the Internet and the stored datagram can be reputedly transmitted according to the broadcasting control information in predetermined interval with the predetermined repetition times.

Hereinafter, operations of the data broadcasting apparatus 20 of the present invention are explained in detail.

The wireless LAN accessing point (AP) is connected to the Internet through a wired or wireless communication link. The data broadcasting apparatus 20 equipped at the wireless LAN accessing point (AP) transmits a datagram for broadcasting to the terminals 13 through the wireless communication link. At this time, the Internet broadcasting 3 server 11 transmits the datagram for broadcasting to the data broadcasting apparatus 20. Inhere, a destination address of the datagram is a unique IP address or unicasting of the wireless LAN accessing point (AP) equipped in the data broadcasting apparatus 20 and, therefore, it can be distinguished according to each of wireless LAN accessing point (AP). Also, pre-defined IP address for broadcasting, multicasting or anycasting can be used as converted destination IP address of the datagram. Furthermore, a received datagram for broadcasting is determined at the data broadcasting apparatus 20 by setting a port number of UDP protocol, which is a high protocol layer, by using a predetermined number and transmitting the port number of UDP protocol. The Internet accessing unit 22 classifies TP address of received datagram and it is transmitted to the control unit 21 when the classified IP address is a unique IP address allocated to the wireless LAN accessing point (AP). If it is not, the wireless LAN accessing point (AP) performs normal operations.

In case of the classified IP address is the address of the wireless LAN accessing point (AP), the broadcasting controller 21 stores data related a size, an interval of broadcasting by confirming the broadcasting control information. The broadcasting controller 21 transmits entire datagram to the address converter 23 and the address converter 23 converts a destination TP address of the datagram to an address for broadcasting, multicasting or anycasting and converted datagram is stored at the data storage 24. The broadcasting controller 21 reputedly transmits the broadcasting data stored in the data storage 24 in every predetermined interval based on the broadcasting control information of the datagram through the wireless communication unit 25.

At this time, the wireless communication unit 25 transmits the datagram for broadcasting and/or datagram for the wireless LAN communication within the wireless communication service area. All terminals 13 located in the wireless communication service area can receive the datagram based on the IP address of broadcasting or multicasting. The terminal 13 can receive the datagram without allocation of IP address since the destination IP address of datagram is for either of broadcasting, multicasting or anycasting address. The datagram is verified as a datagram for broadcasting by checking a port number and existence of UDP datagram in the received datagram. The received datagram is passed to an application program of the terminal 13 for performing to display texts and/or play sounds or image data included in the datagram according to suitable playing method. Also, desired portion of contents included in the datagram can be played by filtering unnecessary received data out according to preset user preference.

FIG. 5 is a flowchart for explaining a method for transmitting broadcasting data within a wireless communication service area in accordance with a preferred embodiment of the present invention.

At step 501, a datagram for broadcasting is constructed at an Internet broadcasting server 11 and the datagram is transmitted to corresponding base station. In step 501, the Internet broadcasting server 11 assigns the protocol ID of 17 as UDP protocol and sets a port number for determining whether the received datagram is a datagram for broadcasting or not. Also, broadcasting control information is inserted at the front of the payload of the UDP datagram.

At step 502, the datagram of the Internet broadcasting server 11 is received through the internet and the broadcasting data apparatus 20 determines whether the received datagram is the datagram for broadcasting or not at step of 503. In the steps 502 and 503, the received datagram is verified by using a destination address included in the datagram, a protocol number or a port number of UDP protocol. Also, combination number of the destination address, the port number or the protocol number can be used for verifying the datagram.

As a result of the determination, if the received datagram is the datagram for broadcasting, the destination address of the datagram is converted at step 504. In step 504, a new destination address has to be suitable for broadcasting in order to receive the datagram by the plural of terminals 13. For example, the new destination address can be one of broadcasting IP address, a multicasting TD address or anycasting IP address. Furthermore, MAC address or datalink address of destination in the frame header can be set to an address for broadcasting or multicasting.

At step 505, the broadcasting controller 21 analyzes broadcasting control information included in the datagram and the datagram is transmitted to the terminals 13 located in the wireless communication service area through the wireless communication unit 25 according to analysis result at step of 506. In steps 505 and 506, transmitted datagram can be stored according to analysis result of the broadcasting controlling information and the stored datagram can be reputedly broadcasted to plural of terminals 13 according to the broadcasting controlling information such as the number of repetition and predetermined interval for broadcasting. Also, information for verification of the Internet broadcasting server 11 and security can be included in the broadcasting controlling information.

In a meantime, the terminal 13 determines whether the received datagram is a datagram for broadcasting or not a step 507. That is, the terminal 13 determines whether IP address of the received datagram is set for broadcasting or not. If the IP address, of the received datagram is set for broadcasting, the terminal 13 also determines whether the received datagram is UDP datagram. Also, the preset port number is determined for verifying the datagram for broadcasting.

If the received datagram is for broadcasting, the terminal 13 outputs the received broadcasting data at step 508. In the step 508, a desired portion of broadcasting data can be played by setting an application program of the terminal 13.

If the received datagram is not for broadcasting, the terminal 13 performs normal operations at step 509.

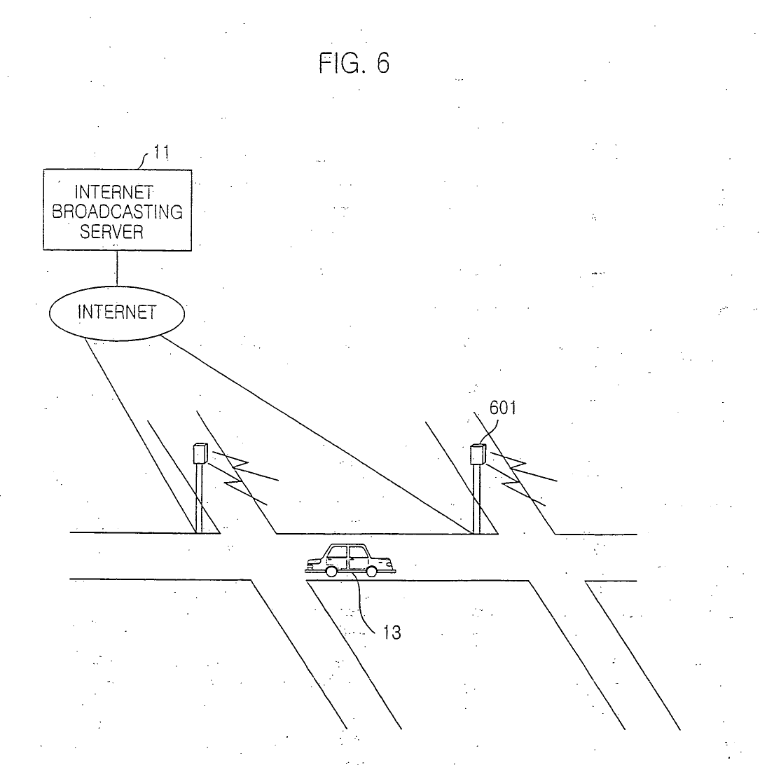

FIG. 6 is a view depicting an example of providing local Internet broadcasting service by using the broadcasting data apparatus 20 in accordance with a preferred embodiment of the present invention. FIG. 6 shows steps for providing local Internet broadcasting service by implementing the broadcasting data apparatus 20 of the present invention in real driveways.

Referring to FIG. 6, a wireless base station including the broadcasting data apparatus 601 is installed at a traffic signal of intersection and a datagram received through the Internet is broadcasted through the wireless base station 601. Therefore, a terminal 13 of vehicle, which is either of stopped or moved, can receive local Internet broadcasting service. The local broadcasting service can include various information such as news for construction of driveway, disaster, stock or weather forecast.

The terminal 13 receiving Internet broadcasting service can receive the datagram without unique IP address allocation since the destination IP address of the datagram is an address for broadcasting, multicasting or anycasting.

For example, the received datagram can be verified as a datagram for broadcasting by checking a port number of the received datagram and by determining whether the received datagram includes a UDP datagram. The application program installed in the terminal 13 plays text, sound, image data included in the received datagram.

For another example, a desired portion of datagram can be selectively using predefined data format and contents. That is, the terminal 13 can display desired data among received broadcasted data by filtering received broadcasted data according to setting of the application program in the terminal by the user. It is very similar to a radio receiver selecting desired broadcasting signal.

For further another example, the port number can be used differently for identifying the broadcasting data.

For still further another example, the header of datagram may include controlling information for constructing display image of the terminal.

For another example, the broadcasted data displayed at the terminal can be implemented as a mark up language in order to provide additional information of the broadcasted data by clicking a line of text linked to corresponding web sites and moving to the corresponding web sits. That is, two-way communication method can be occasionally provided.

For another example, an application program for playing the received broadcasted data can also be transmitted for improving the playing mode of the datagram or changing display image of the terminal.

For another example, in a case that a plurality of terminals having capable of wireless communication is communicated each others, the datagram for broadcasting received by one terminal can be shared and transmitted to other terminals.

For another example, consecutive distinction number can be assigned to header of the datagram for transmitting consecutive broadcasting datagram.

The present invention can be implemented not only to wireless LAN but also a wireless communication device for short and long distance communication including a mobile communication base station, a wireless beacon, a mobile dedicated short range communication (DSRC), a Bluetooth base station and information communication device including a router and an exchanger for data.

Also, the present invention can be implemented not only to local broadcasting service but also wide area broadcasting service such as a sky wave broadcasting, a cable TV and a satellite TV broadcasting service.

The above-mentioned method of the present invention can be implemented as a program and the program can be stored into a computer readable recording medium including CD-Rom, RAM, ROM, floppy desk, hard disk and magneto-optic disk.

As above mentioned, the present invention can effectively provide valuable local information to users of specific area. That is, distinct information according to area can be provided by using wireless base station installed in each area.

Also, the present invention can eliminate a complex problem of allocation IP address of terminals for Internet broadcasting service since each of receivers does not require a unique IP address allocation.

Furthermore, the present invention increase efficiency of providing broadcasting data from the Internet broadcasting server by reputedly transmitting previously broadcasted data in predetermined interval and predetermined times.

Moreover, the users can receive broadcasting information by using the Internet while they are moving. That is, a terminal of the user automatically receives the broadcasting data by entering boundary of specific area.

The present invention can reduce a workload of the Internet broadcasting server although the number of receivers of the internet broadcasting service is increased.

While the present invention has been described with respect to certain preferred embodiments, it will be apparent to those skilled in the art that various changes and modifications may be made without departing from the scope of the invention as defined in the following claims.

1. An apparatus for broadcasting data within a wireless communication service area, comprising
broadcasting control means for controlling to provide broadcasting data service within the wireless communication service area;
Internet access means for receiving a datagram of the broadcasting data service through the Internet under control of the broadcasting control means;
address convert means for converting a destination address of the datagram to a predetermined type of address suitable for broadcasting under control of the broadcasting control means; and
wireless communication means or transmitting the datagram having the predetermined type of address based on a predetermined communication method to corresponding terminal located within the wireless communication service area under control of the broadcasting controlling means.

2. The apparatus as recited in the claim 1, further comprising:
data store means for storing the datagram having the predetermined type of address and reputedly transmitting the stored datagram in every predetermined interval based on the predetermined communication method through the wireless communication means.

3. The apparatus as recited in claim 1, further comprising:
additional power supply means for supplying additional power to the apparatus in order to provide a broadcasting data service in case of emergency situation.

4. The apparatus as recited in claim 1, wherein the terminal receives the Internet broadcasting data service within the wireless communication service area without setting of an internet broadcasting server address, selectively displays a desired data among received datagram and provides additional information of received data by implementing Internet links between corresponding web sites and received data.

5. The apparatus as recited in claim 1, wherein the terminal automatically detects a wireless communication network for receiving broadcasting data within the wireless communication service area.

6. The apparatus as recited in claim 1, wherein the terminal transmits a datagram for broadcasting to other terminal within the wireless communication service area.

7. The apparatus as recited in claim 1, wherein the datagram is transmitted from an Internet broadcasting server to the apparatus having a corresponding destination address through wired/wireless Internet and identical broadcasting data is transmitted only one time to the apparatus for broadcasting local area information.

8. The apparatus as recited in claim 1, wherein the datagram includes a consecutive distinction number in a header of the datagram for continuously transmitting consecutive datagrams for broadcasting.

9. The apparatus as recited in claim 1, wherein the datagram includes broadcasting control information for controlling to broadcast the datagram based on the broadcasting control information by the broadcasting control means and storing the broadcasting control information at the data store means, wherein the broadcasting control information includes a store order field for determining whether the datagram is stored or not, a broadcasting time field for determining a broadcasting time, a broadcasting repetition field containing the number of repetition times, interval, priority and size.

10. The method as recited in claim 13, wherein the predetermined type of address for destination IP address is one of broadcasting IP address, multicasting IP address and anycasting IP address, and the MAC address or the data link address added in front of the datagram, are set as one of a broadcasting address or multicasting address or the terminals to received broadcasting data within the wireless communication service area.

11. The apparatus as recited in claim 1, wherein the internet accessing means determines a received datagram whether the received datagram is a datagram for broadcasting by using a destination address included in the datagram, a protocol number, a port number of user datagram protocol (UDP) or combination of the destination address, the protocol number and the port number under controlling broadcasting control means.

12. The apparatus as recited in claim 1, wherein the broadcasting control means analyzes the broadcasting control information included in the datagram, controls to transmit the datagram according to a result of analyzing the broadcasting control information, stores the transmitted datagram for reputedly broadcasting identical datagram and control to reputedly broadcast the datagram to plural of terminals in every predetermined interval and repetition times.

13. A method for broadcasting data in a service area or wireless communication, comprising the steps of:
a) receiving a datagram for broadcasting through Internet;
b) converting a destination address of the datagram to a predetermined type of address suitable for broadcasting; and
c) transmitting the converted datagram having, the predetermined type of address according to the predetermined communication method to corresponding terminal within the service area of the wireless communication.

14. The method as recited in the claim 13, further comprising the step of d) storing the converted datagram having the predetermined type of address and reputedly transmitting the converted datagram within a predetermined time.

15. The method as recited in the claim 13, wherein the terminal receives the Internet broadcasting service within the wireless communication service area without presetting of an Internet broadcasting server address, selectively plays a desired data among received datagram and provides additional information of received data by implementing Internet links between corresponding web sites and received data.

16. The method as recited in claim 13, wherein the terminal automatically detects a wireless communication network for receiving broadcasting data within the wireless communication service area.

17. The method as recited in claim 13, wherein the terminal transmits a datagram for broadcasting to other terminal within the wireless communication service area.

18. The method as recited in claim 13, wherein the predetermined type of address for destination is address is one of broadcasting IP address, multicasting IP address and anycasting IP address, and the MAC address or the data link address added in front of the datagram, are set as one of a broadcasting address or multicasting address for the terminals to received broadcasting data within the wireless communication service area.

19. The method as recited in claim 13, wherein the datagram includes broadcasting control information for controlling to broadcast the datagram based on the broadcasting control information by the broadcasting control means and storing the broadcasting control information at the data store means, wherein the broadcasting control information includes a store order field for determining whether the datagram is stored or not, a broadcasting time field for determining a broadcasting time, a broadcasting repetition field containing the number of repetition times, interval, priority and size.

20. The method as recited in claim 13, wherein the datagram a consecutive distinction number is included in a header for transmitting of consecutive datagram for broadcasting.

21. A computer readable recording medium for recording a program for implementing a method of broadcasting data in a service area of wireless communication, comprising the functions of:
a) receiving a datagram for broadcasting through the internet;
b) converting a destination IP address of the datagram to a predetermined type of IP address suitable for broadcasting; and
c) transmitting the converted datagram having the predetermined type of address according to the predetermined communication method to corresponding terminal within the service area of the wireless communication.

22. The computer readable recording medium as recited in the claim 21, further comprising the function of d) storing the converted datagram having the predetermined type of address and reputedly transmitting the converted datagram within a predetermined time.
